(19) United States
(12) Patent Application Publication
(10) Pub. No.: US 2013/0019372 A1
(43) Pub. Date: Jan. 24, 2013

(54) SENSOR-RESPONSIVE LIGHTING MODULE AND CLOTHING ARTICLE

(71) Applicant: Ezra ESSES, Brooklyn, NY (US)

(72) Inventor: Ezra ESSES, Brooklyn, NY (US)

(73) Assignee: E. S. ORIGINALS, INC., New York, NY (US)

(21) Appl. No.: 13/185,901

(22) Filed: Jul. 19, 2011

(51) Int. Cl. H05B 37/02; A41D 1/00

(52) U.S. Cl. 2/69; 315/312; 315/313

(57) ABSTRACT

A sensor-responsive lighting module is permanently attached to an article of clothing and has multiple water-resistant, lighting units connected to, and spaced from, a water-resistant, control unit by water-resistant, encapsulated wire pairs. Each lighting unit has an upright lens portion that protrudes through an aperture in a juxtaposed panel that bears a graphic design. Each unit has a strain relief portion to resist breakage of end regions of the wire pairs during article wear.

### BACKGROUND OF THE INVENTION

The present invention generally relates to lighting assemblies that are affixed to, and embellish, articles of clothing and, more particularly, to garments illuminated by such assemblies in response to motion by a wearer.

It is generally known to mount miniaturized lighting assemblies on garments for providing them with a more visually stimulating appearance. For example, U.S. Pat. No. 7,278,758 discloses a motion-responsive, water-resistant, lighting module having on-board, light emitting diodes (LEDs) that emit light through a light-transmissive overlay attached to a garment. However, as satisfactory as such lighting modules have been, the placement of the LEDs within the module limits the extent to which the emitted light is visible on the garment. Thus, a graphic design applied on the overlay can only be illuminated by the LEDs that are situated within the boundaries of the lighting module, which, in some applications, can encompass an area of less than two square inches.

It is also known, for example, from U.S. Pat. No. 5,113,325, to mount multiple LEDs outboard of a central actuation unit of a lighting assembly so that a larger area of a graphic design on a garment may be illuminated. However, as advantageous as such a lighting assembly can be, there are drawbacks in placing the LEDs outside the central actuation unit. For example, such a lighting assembly is not water-resistant and would be prone to damage if left on the garment during laundering. As a result, this lighting assembly must be removed from the garment prior to cleaning. In addition, the LEDs are connected to the central actuation unit by wires, and these wires flex repeatedly during wear. As a result, these wires are prone to cracking and breakage, especially during active wear, with consequent failure of the lighting assembly to function.

### SUMMARY OF THE INVENTION

Accordingly, it is a general object of this invention to provide a reliable, water-resistant, visually stimulating, eye-catching display over a wide area on a garment.

In keeping with the above object and others which will become apparent hereinafter, one feature of the present invention resides, briefly stated, in a sensor-responsive lighting module, which comprises a plurality of water-resistant, lighting units for emitting light; a water-resistant, control unit; and a plurality of water-resistant, encapsulated wire pairs, each wire pair extending over a predetermined length between the control unit and each lighting unit.

Each lighting unit includes a lighting enclosure molded of synthetic plastic material, for encapsulating a light emitting diode (LED) mounted on a generally planar lighting board within the lighting enclosure. Each lighting enclosure is comprised of a base portion and an upright lens portion that overlies the respective LED and that extends outwardly away from the respective base portion in a direction generally perpendicular to the respective lighting board. Each lighting enclosure is further comprised of a first strain relief portion that is molded of a one-piece construction with the respective base portion and the respective upright lens portion.

The control unit includes a control enclosure molded of synthetic plastic material, and comprised of a main portion for encapsulating a control processor, a battery, and a sensor or switch, preferably a motion-responsive switch, for connecting the battery to the control processor in response to actuation of the sensor, e.g., motion of the switch. The control enclosure is further comprised of a plurality of second strain relief portions that are molded of a one-piece construction with the main portion.

Each wire pair electrically connects the control processor to each LED to emit light in response to the actuation of the sensor. Each wire pair has a first wire end region extending through a respective first strain relief portion in a direction generally parallel to the respective lighting board within the respective lighting enclosure, and being encapsulated by the respective first strain relief portion to resist stress on the first wire end region. Each wire pair has a second wire end region extending through, and being encapsulated by, a respective second strain relief portion to resist stress on the second wire end region.

In a preferred embodiment, each upright lens portion has an outer curved surface for spreading and amplifying the light emitted from the respective LED that is overlain by the respective upright lens portion. In addition, the base portion and the first strain relief portion of each lighting enclosure have a common, generally planar, bottom surface. The control unit preferably includes a generally planar control board on which the control processor is mounted, and the control board is encapsulated by the main portion. The control processor is preferably operative for intermittently lighting the LEDs in a flashing pattern in response to the actuation of the sensor. The motion-responsive switch advantageously includes an electrically conductive coil spring mounted within an electrically conductive sleeve for movement between an open position in which the spring is spaced from the sleeve, to a closed position in which the spring contacts the sleeve. The predetermined lengths of the wire pairs can be the same or different.

In accordance with another feature of the present invention, the module is juxtaposed with a panel having apertures at predetermined locations and extending through the panel. The panel can be a cover, or a garment component of the clothing article. For example, if the clothing article is a shirt, then the garment component is a shirt front. The cover can be an outer component of an appliqué or patch to be attached to the clothing article. The panel advantageously has a graphic design thereon. The graphic design can be any visual representation applied in any manner to the panel. Preferably, the apertures are situated relative to the graphic design to embellish the design with light during wear. Each upright lens portion extends through a respective aperture in the panel to conduct the emitted light outwardly past the panel. The module may further comprise a backing lying underneath the units and the wire pairs and being connected to the panel. The backing, together with the cover, sandwich the module therebetween and comprise the appliqué or patch that can be attached to the clothing article, preferably permanently, for example, by a heat-fused seal or by stitching.

In accordance with this invention, the molded enclosures insure that each unit is watertight, and that the garment can be laundered without removal of the module. The molded strain reliefs insure that the wire pairs will resist cracking and breakage during wear, especially by feeding each first wire end region through the respective first strain relief portions in a direction generally parallel to the respective lighting board within the respective lighting enclosure. The strain reliefs thus help position the wire pairs to lie generally flat relative to, and against, a wearer's body. The flashing lights create an eye-catching display whether the garment is worn by day or by night.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a front elevational view of a garment in accordance with this invention;

FIG. 2 is a front elevational view of a lighting module in accordance with this invention;

FIG. 3 is an enlarged sectional view taken on line 3-3 of FIG. 2;

FIG. 4 is an enlarged sectional view taken on line 4-4 of FIG. 2;

FIG. 5 is an electrical schematic of a circuit used in the lighting module of FIG. 2;

FIG. 6 is an enlarged sectional view of the lighting module of FIG. 2 attached underneath the garment of FIG. 1 in accordance with one embodiment of this invention; and

FIG. 7 is an enlarged sectional view of the lighting module of FIG. 2 attached above the garment of FIG. 1 in accordance with another embodiment of this invention.

### DETAILED DESCRIPTION OF THE PREFERRED EMBODIMENTS

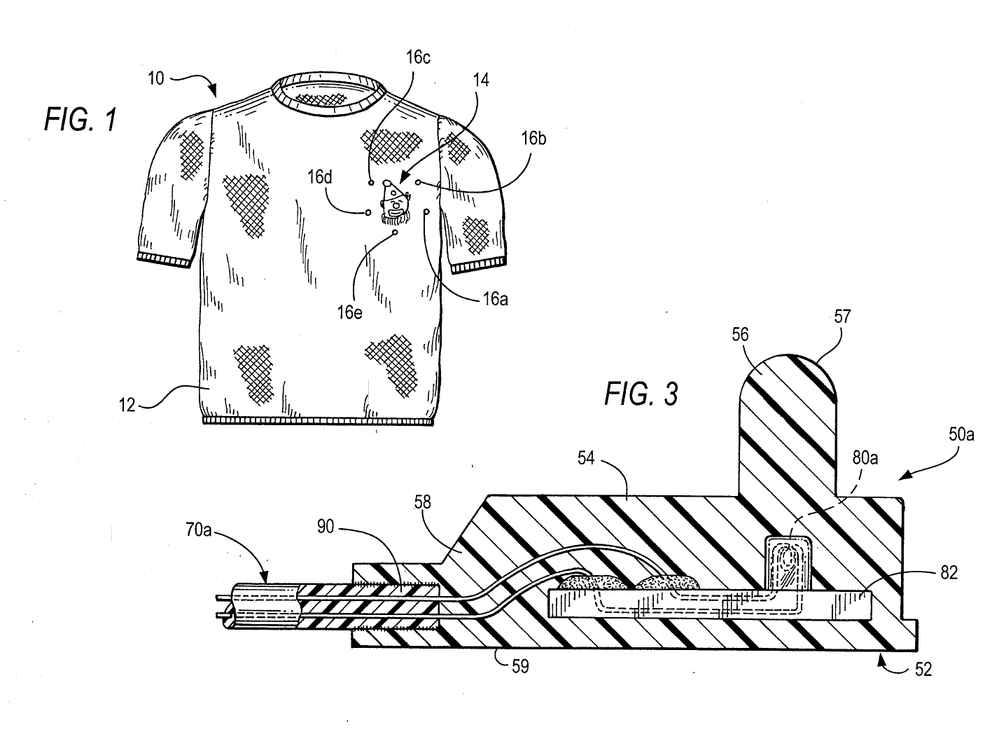

Referring now to the drawings, reference numeral 10 in FIG. 1 generally identifies a sensor-responsive article of clothing or garment, such as a shirt or blouse, having a panel 12, e.g., a garment component such as a shirt front. The garment 10 is preferably made of a soft, flexible material, such as cotton, wool, nylon, silk, or like fabric or cloth materials. A graphic design 14, as illustrated, a clown's face, is applied, e.g., by silk screening, on the panel 12. The graphic design 14 can be any visual representation applied in any manner to the panel 12. Multiple apertures 16a, 16b, 16c, 16d, and 16e extend through the panel 12 and are arranged in a desired pattern, as illustrated, an annulus, relative to the design 14.

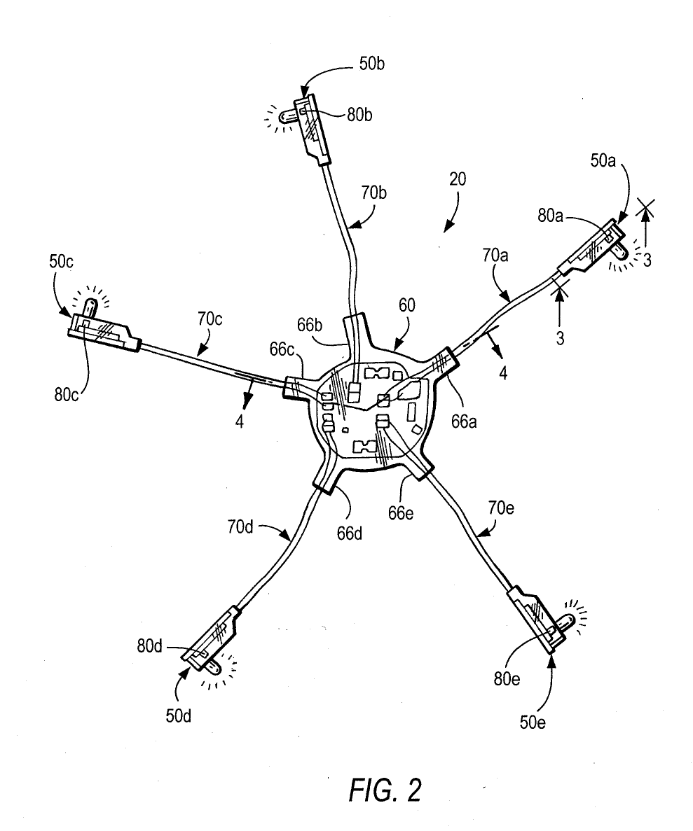

Reference numeral 20 in FIG. 2 generally identifies a sensor-responsive lighting module, which comprises a plurality of water-resistant, lighting units 50a, 50b, 50c, 50d, and 50e for emitting light from light emitting diodes (LEDs) 80a, 80b, 80c, 80d, and 80e (see FIG. 5); a water-resistant, control unit 60; and a plurality of water-resistant, encapsulated wire pairs 70a, 70b, 70c, 70d, and 70e, each wire pair extending over a predetermined length between the control unit 60 and each lighting unit 50a, 50b, 50c, 50d, and 50e. As illustrated, the predetermined lengths of the wire pairs are the same, but they can be different to accommodate different locations of the apertures 16a, 16b, 16c, 16d, and 16e relative to the control unit 60, as described below.

Each lighting unit 50a, 50b, 50c, 50d, and 50e, as shown for representative lighting unit 50a in FIG. 3, includes a lighting enclosure 52 molded of a light-transmissive, synthetic plastic material, for encapsulating representative LED 80a mounted on a generally planar, lighting printed circuit board 82 within the lighting enclosure 52. The LEDs 80a, 80b, 80c, 80d, and 80e are operative for emitting light of the same or different colors. Each LED 80a, 80b, 80c, 80d, and 80e includes a pair of planar electrodes, which are mounted on an outer planar surface of the lighting board 82.

Each lighting enclosure 52 is comprised of a generally rectangular parallelepiped base portion 54 and an upright cylindrical lens portion 56 that overlies the respective LED and that extends outwardly away from the respective base portion 54 in a direction generally perpendicular to the respective lighting board 82. Each upright cylindrical lens portion 56 has a convexly curved outer surface 57 for spreading and amplifying the light emitted from the respective LED that is overlain by the respective upright lens portion 56. Each lighting enclosure 52 is further comprised of a first tapered strain relief portion 58 that is molded of a one-piece construction with the respective base portion 54 and the respective upright lens portion 56. The tapered strain relief portion 58 at least partially decreases in thickness in a direction away from the base portion 54 and shares a common generally planar bottom surface 59 with the base portion 54.

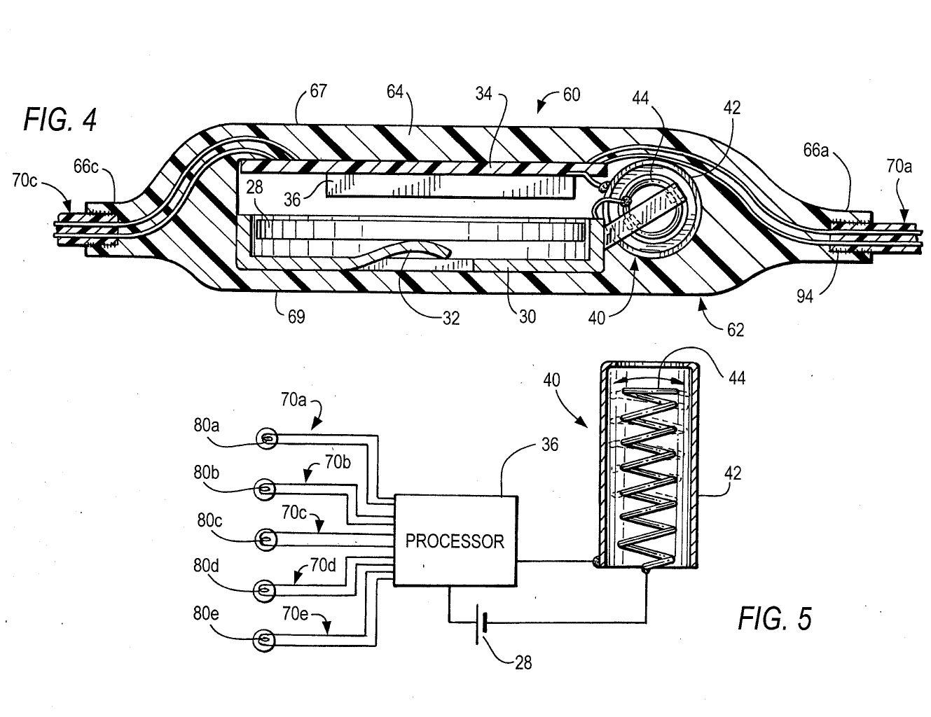

As best seen in FIG. 4, the control unit 60 includes a control enclosure 62 molded of a synthetic plastic material, preferably, but not necessarily, light-transmissive, and comprised of a generally circular, disk-shaped, main portion 64 for encapsulating a control processor 36, a battery 28, typically a flat circular disk battery commonly used in cameras, and a sensor or switch 40 for connecting the battery 28 to the control processor 36 in response to actuation of the sensor 40, as described below. A battery holder 30 having a resilient finger 32 engages one side of the battery. The main portion 64 has a generally flattened outer surface 67 and a generally flattened inner surface 69. The control enclosure 62 is further comprised of a plurality of second tapered strain relief portions 66a, 66b, 66c, 66d, and 66e, that are molded of a one-piece construction with the main portion 64 and that are angularly spaced apart around the main portion. Each tapered strain relief portion 66a, 66b, 66c, 66d, and 66e at least partially decreases in thickness in a direction away from the main portion 64.

The control unit 60 further includes a generally planar, control printed circuit board 34 on which the control processor 36 is mounted, and the control board 34 is also encapsulated by the main portion 64. The control processor 36 is operative for intermittently lighting the LEDs 80a, 80b, 80c, 80d, and 80e in a flashing pattern in response to the actuation of the sensor 40. The sensor 40 can be a motion-responsive switch, in which case, the switch includes an electrically conductive outer sleeve 42 in which an electrically conductive coil spring 44 is mounted for movement between an open position in which the spring 44 is located out of physical conductive contact with the sleeve 42, and a closed position in which the spring 44 contacts the sleeve 42. Motion of the spring 44 is caused by movement of the wearer of the garment 10 and, to aid such spring motion, the free end of the cantilevered spring 44 can be weighted.

FIG. 5 illustrates how the battery 28, the motion-responsive switch 40, the processor 36 and the LEDs 80a, 80b, 80c, 80d, and 80e are interconnected. In the closed position of the switch 40, the processor 36 is energized by the battery 28 and causes the LEDs 80a, 80b, 80c, 80d, and 80e to emit light, preferably flashes of light in a pattern determined by the processor 36. The pattern may be predetermined or random. The flashing can occur immediately when the closed position is reached, or after a time delay. The flashing is terminated after a predetermined time, or after a randomly chosen time interval. Continuous illumination is contemplated, but not preferred to minimize power consumption.

As described above, each wire pair 70a, 70b, 70c, 70d, and 70e extends generally radially outwardly of the main portion 64 and electrically connects the control processor 36 to each LED to emit light in response to the actuation of the sensor 40. Each wire pair, as shown in FIG. 3 for representative wire pair 70a, has a first wire end region 90 extending through a respective first strain relief portion 58 in a direction generally parallel to the respective lighting board 82 within the respective lighting enclosure 52, and being encapsulated by the respective first strain relief portion 58 to resist stress on the first wire end region 90. Each wire pair, as shown in FIG. 4 for representative wire pair 70a, also has a second wire end region 94 extending through, and being encapsulated by, a respective second strain relief portion 66a to resist stress on the second wire end region 94.

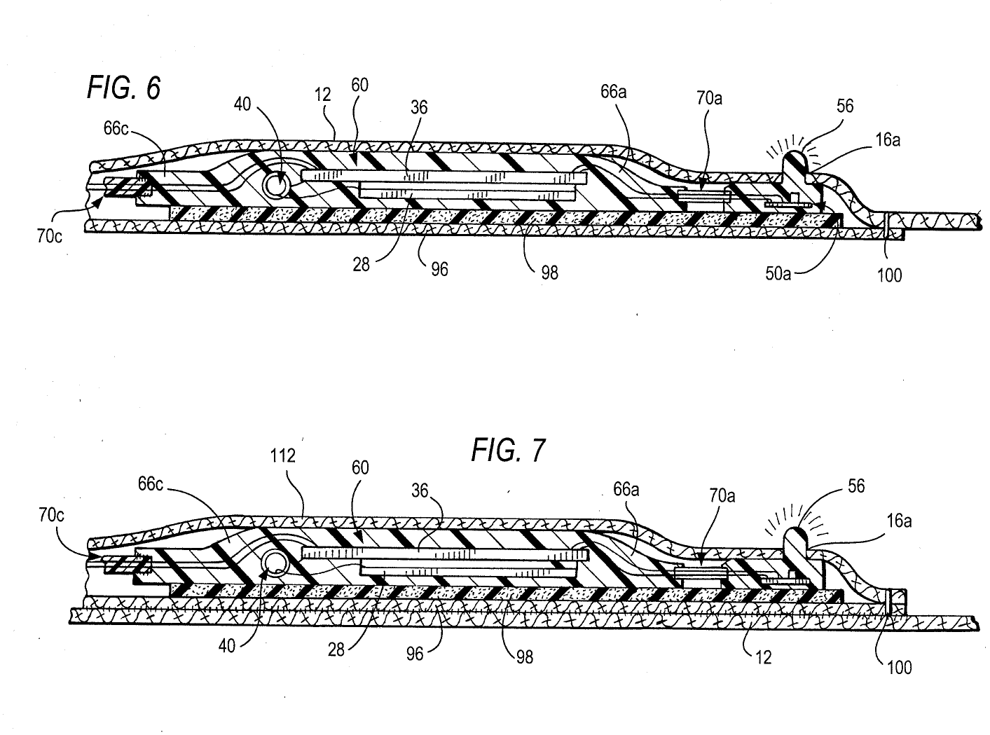

In accordance with another feature of the present invention, the module 20 of FIG. 2 is juxtaposed with the apertured panel 12 of FIG. 1. Each upright lens portion 56 is positioned to extend and protrude through a respective aperture 16a, 16b, 16c, 16d, and 16e in the panel 12 to conduct the emitted, spread and amplified light outwardly past the panel 12. Thus, as shown in FIG. 6, the lens portion 56 extends through aperture 16a, and the entire module 20, except for the protruding lens portion 56, is positioned directly underneath the panel 12. A backing 96, preferably a cloth, vinyl, or fabric sheet, is positioned underneath the module 20 and is connected to the panel 12, preferably permanently, for example, by a heat-fused seal or by stitching, at peripheral region 100. A resilient member, preferably, a foam pad 98, is positioned between the backing 96 and the underside of the module 20 to hold the module in place and to provide a measure of comfort against the wearer's body.

As described so far, the apertured panel 12 bearing the graphic design 14 is a component of the garment 10, e.g., the shirt front. However, this panel can also be an outer cover of an appliqué or patch that is attached to the clothing article 10. Thus, as shown in FIG. 7, which is analogous to FIG. 6, an appliqué comprises an outer part or cover 112, preferably, a cloth, vinyl, or fabric sheet, that overlies and is peripherally attached at region 100, preferably by a heat-fused seam or by stitching, to an inner part or the aforementioned backing 96. The module 20 is located between, and is sandwiched by, the cover 112 and the backing 96. As described above, the aforementioned foam pad 98 may be positioned inside the appliqué between the backing 96 and the underside of the module 20. The cover 112 advantageously has the graphic design 14 thereon. The apertures 16a, 16b, 16c, 16d, and 16e extend through the cover 112 and are situated relative to the graphic design 14 to embellish the design with light during wear. The graphic design 14 can be any visual representation applied in any manner to the cover 112. The appliqué is preferably attached on top of the clothing article 10, preferably permanently, for example, by a heat-fused seal or by stitching.

In a variant construction, the backing 96 could be eliminated, in which case, the cover 112 sandwiches the module 20 between itself and the clothing article 10. In another variant construction, the appliqué is attached below the clothing article 10, in which case, both the cover 112 and the clothing article 10 have aligned apertures through which each lens portion 56 protrudes.

In accordance with this invention, the molded enclosures 52 and 62 insure that each unit 50a, 50b, 50c, 50d, 50e and 60 is watertight, and that the clothing article 10 can be laundered without removal of the module 20. The molded strain reliefs 66a, 66b, 66c, 66d, 66e and 58 insure that the wire pairs 70a, 70b, 70c, 70d, and 70e are water-tight and will resist cracking and breakage during wear, especially by feeding each first wire end region 90 through the respective first strain relief portions 58 in a direction generally parallel to the respective lighting board 82 within the respective lighting enclosure 52. The strain reliefs thus help position the wire pairs to lie generally flat relative to, and against, a wearer's body. The flashing lights create an eye-catching display whether the garment is worn by day or by night.

In use, even if a force presses the module 20 against the wearer, there is little discomfort, because the module 20 has no exposed rough edges and is cushioned by the pad 98 and/or by the backing 96 and/or by the garment 10 itself. As the wearer moves, the light emitted by the LEDs passes through the light-transmissive encapsulating lighting enclosure 52 and illuminates the graphic design 14.

It will be understood that each of the elements described above, or two or more together, also may find a useful application in other types of constructions differing from the types described above. For example, the garment need not be a shirt as illustrated, but can be any clothing article, including hats and gloves. The number of lighting units, apertures and wire pairs need not be five as illustrated, but could be any number. The arrangement of the apertures need not be the annulus as illustrated, but could be any desired arrangement. The sensor need not be a motion-responsive switch 40 as illustrated, but could equally well be a sensor that detects sounds, light, or moisture, or any combination thereof. Thus, the sensor could actuate the LEDs when it detects sounds above a certain threshold, or when it detects light intensity levels indicative of nighttime instead of daytime, or when it detects water, for example, during swimming.

While the invention has been illustrated and described as embodied in a sensor-responsive lighting module and article of clothing, it is not intended to be limited to the details shown, since various modifications and structural changes may be made without departing in any way from the spirit of the present invention. By way of example, the panel 12 need not be apertured, but, in a variant construction, can be a non-apertured, light-transmissive panel that entirely overlies the module, in which case, the emitted light from the LEDs would pass through the light-transmissive material of the panel, rather than through apertures.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

1. A sensor-responsive lighting module, comprising:
a plurality of water-resistant, lighting units for emitting light, each lighting unit including a lighting enclosure molded of synthetic plastic material, for encapsulating a light emitting diode (LED) mounted on a generally planar lighting board within the lighting enclosure, each lighting enclosure being comprised of a base portion and an upright lens portion that overlies the respective LED and that extends outwardly away from the respective base portion in a direction generally perpendicular to the respective lighting board, each lighting enclosure being further comprised of a first strain relief portion that is molded of a one-piece construction with the respective base portion and the respective upright lens portion;
a water-resistant, control unit including a control enclosure molded of synthetic plastic material, and being comprised of a main portion for encapsulating a control processor, a battery, and a sensor for connecting the battery to the control processor in response to actuation of the sensor, the control enclosure being further comprised of a plurality of second strain relief portions that are molded of a one-piece construction with the main portion; and
a plurality of water-resistant, encapsulated wire pairs, each wire pair extending over a predetermined length between the control unit and each lighting unit, for electrically connecting the control processor to each LED to emit light in response to the actuation of the sensor, each wire pair having
a first wire end region extending through a respective first strain relief portion in a direction generally parallel to the respective lighting board within the respective lighting enclosure, and being encapsulated by the respective first strain relief portion to resist stress on the first wire end region, and
a second wire end region extending through, and being encapsulated by, a respective second strain relief portion to resist stress on the second wire end region.

2. The module of claim 1, wherein each upright lens portion has an outer curved surface for spreading the light emitted from the respective LED that is overlain by the respective upright lens portion.

3. The module of claim 1, wherein the base portion and the first strain relief portion of each lighting enclosure have a common, generally planar, bottom surface.

4. The module of claim 1, wherein the control unit includes a generally planar control board on which the control processor is mounted, and wherein the control board is encapsulated by the main portion.

5. The module of claim 1, wherein the control processor is operative for intermittently lighting the LEDs in a flashing pattern in response to the actuation of the sensor.

6. The module of claim 1, wherein the sensor is a motion-responsive switch that includes a coil spring mounted within a sleeve for movement between an open position in which the spring is spaced from the sleeve, and a closed position in which the spring contacts the sleeve.

7. The module of claim 1, and further comprising a cover overlying the control unit and the wire pairs, and having apertures at predetermined locations through the cover, and wherein each upright lens portion extends through a respective aperture to conduct the emitted light outwardly past the cover.

8. The module of claim 7, wherein the cover has a graphic design thereon.

9. The module of claim 7, and further comprising a backing lying underneath the units and the wire pairs and being connected to the cover.

10. A sensor-responsive article of clothing, comprising:
a panel having a graphic design thereon; and
a sensor-responsive lighting module juxtaposed with the panel, the module including
a plurality of water-resistant, lighting units for emitting light, each lighting unit including a lighting enclosure molded of synthetic plastic material, for encapsulating a light emitting diode (LED) mounted on a generally planar lighting board within the lighting enclosure, each lighting enclosure being comprised of a base portion and an upright lens portion that overlies the respective LED and that extends outwardly away from the respective base portion in a direction generally perpendicular to the respective lighting board, each lighting enclosure being further comprised of a first strain relief portion that is molded of a one-piece construction with the respective base portion and the respective upright lens portion,
a water-resistant, control unit including a control enclosure molded of synthetic plastic material, and being comprised of a main portion for encapsulating a control processor, a battery, and a sensor for connecting the battery to the control processor in response to actuation of the sensor, the control enclosure being further comprised of a plurality of second strain relief portions that are molded of a one-piece construction with the main portion, and
a plurality of water-resistant, encapsulated wire pairs, each wire pair extending over a predetermined length between the control unit and each lighting unit, for electrically connecting the control processor to each LED to emit light through the panel in response to the actuation of the sensor, each wire pair having a first wire end region extending through a respective first strain relief portion in a direction generally parallel to the respective lighting board within the respective lighting enclosure, and being encapsulated by the respective first strain relief portion to resist stress on the first wire end region, and each wire pair further having a second wire end region extending through, and being encapsulated by, a respective second strain relief portion to resist stress on the second wire end region.

11. The clothing article of claim 10, wherein the panel overlies the module and is one of a cover and a garment component of the clothing article.

12. The clothing article of claim 10, wherein the panel has a plurality of apertures extending through the panel, and wherein each upright lens portion extends through a respective aperture.

13. The clothing article of claim 12, wherein the apertures are arranged at predetermined locations relative to the graphic design.

14. The clothing article of claim 12, wherein each upright lens portion has an outer curved surface for spreading the light emitted through the respective aperture from the respective LED that is overlain by the respective upright lens portion.

15. The clothing article of claim 10, and further comprising a backing lying underneath the units and the wire pairs and being connected to the panel.

16. The clothing article of claim 15, and further comprising a resilient pad lying underneath the units and the wire pairs and lying above the backing.

17. The clothing article of claim 10, wherein the base portion and the first strain relief portion of each lighting enclosure have a common, generally planar, bottom surface.

18. The clothing article of claim 10, wherein the control unit includes a generally planar control board on which the control processor is mounted, and wherein the control board is encapsulated by the main portion.

19. The clothing article of claim 10, wherein the control processor is operative for intermittently lighting the LEDs in a flashing pattern in response to the actuation of the sensor.

20. The clothing article of claim 10, wherein the sensor is a motion-responsive switch that includes a coil spring mounted within a sleeve for movement between an open position in which the spring is spaced from the sleeve, and a closed position in which the spring contacts the sleeve.
